(19) United States
(12) Patent Application Publication
(10) Pub. No.: US 2006/0279064 A1
(43) Pub. Date: Dec. 14, 2006

(54) Hidden stem

(76) Inventor: Costa Vincenzo F., Huntington Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 11/408,370

(22) Filed: Apr. 21, 2006

Related U.S. Application Data
(63) Continuation-in-part of application No. 11/138,811, filed on May 26, 2005.

(51) Int. Cl. B62K 1/00

(52) U.S. Cl. 280/280

(57) ABSTRACT

A fork assembly has an upper or lower fork tree; a steering stem aperture formed in the upper or lower fork tree; and a steering stem having an upper or lower end that fits within the steering stem aperture. A button fits within a upper or bottom opening of the upper or lower fork tree covering the upper or lower end of the steering stem within the upper or lower fork tree.

This application is a continuation in part application of Ser. No. 11/138,811.

### DISCUSSION OF RELATED ART

A motorcycle suspension system is an important part of the functional as well as aesthetic constitution of the motorcycle. Custom motorcycles are an art form as well as functional. In any motorcycle aesthetics predominate and a substantial consideration in value and pricing.

Typically, a front motorcycle front suspension has a pair of fork legs having springs and shocks mounted internally. An alternate suspension is a springer type suspension that provides a steering suspension with a fixed pair of fork legs formed as stanchion tubes pivotally mounted with a rocker arm that provides support in connection with one or more push rods. Both of these suspensions have a fork tree, or fork clamp that connects the pair of fork legs to the steering stem and the rest of the motorcycle frame. Traditionally, motorcycle steering stems are bolted to a fork tree.

The fork tree connector traditionally clamped the fork tubes and included a steering stem pivotal connection. The steering stem traditionally has a threaded connection connecting to the fork tree connector clamp. The fork tree surface being flat readily accommodated the threaded connection that traveled through the entire thickness of the of fork tree clamp. The steering stem thus required a separate cap. The cap was typically mounted by a threaded connection to the steering stem. More recently, the cap has been made out of billet material in an attempt to upgrade the configuration. From the current state of the art, a variety of improvements can be made in the fork tree steering stem connection.

### BRIEF DESCRIPTION OF THE DRAWINGS

FIG. 1 is a perspective exploded view of the device.

FIG. 2 is a perspective exploded view of the device showing fork legs and steering column.

FIG. 3 is a top view of the clamp.

FIG. 4 is a cross section view of the clamp.

### DETAILED DESCRIPTION OF THE PREFERRED EMBODIMENT

An upper fork tree, or clamp has a pair of apertures receiving the upper end of a stanchion tube. Stanchion means an upright pole, tube, post, or support typical of a fork tree tube. The upper fork tree 27 receives a pair of pinch bolts 29 retaining the stanchion tube 1. The bottom portion of the stanchion tube is attached to the front wheel axle that is attached to the rotating front wheel.

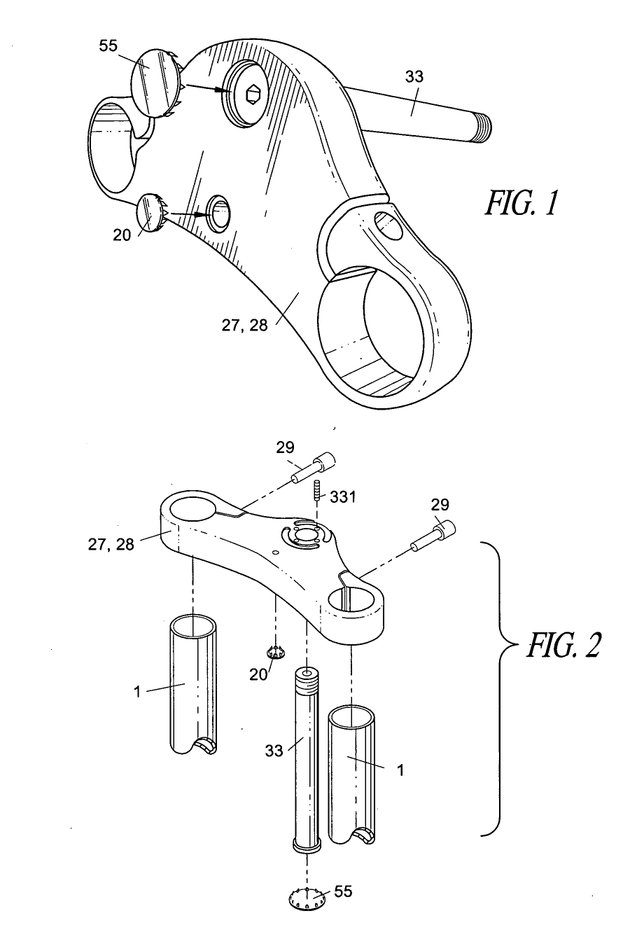

As seen in FIG. 1, the upper fork 27 receives a steering stem 33 in a steering stem aperture. The steering stem aperture is circular and passes through the entire thickness of the fork tree. The fork tree has a top and bottom face that has the aperture. Each face has an opening. The bottom face of the bottom steering stem can have a bottom opening receiving the button. The top face of the top steering stem can have a top opening receiving the button. The steering stem is threaded into the aperture and has a hexagonal rotation drive to receive a tool. The steering stem protrudes approximately perpendicular from the plane of the upper fork tree 27 and preferably has thread that engages with thread formed in the steering stem aperture of the upper fork 27. The lower fork 28 can be similarly configured to receive the bottom end of the steering stem 33. The bottom end of the steering stem 33 is also threaded and can have a hexagonal rotation connection for receiving a tool. The steering stem 33 is typically a solid cylindrical material of steel or aluminum but can also be hollow. The steering stem is configured to insert into the steering stem aperture up to a certain distance so that the steering stem 33 is less than flush from the surface of either the upper 27 or lower fork leg 28.

The steering stem receives a large button 55 that covers the steering stem aperture. The small button 20 covers the small aperture. The large button 55 and small button 20 have a number of protruding prongs acting as leaf springs that respectively engage with the inside surface of the steering stem aperture or the inside surface of the small aperture. The small button 20 is the headlight button covering the small aperture which is the headlight aperture. The large button 55 covers the large aperture which is the steering stem aperture.

During assembly, as seen in FIG. 2, the steering stem receives a bolt 331 that blocks the steering stem in place. The bolt prevents rotation of the steering stem. A pair of bolts 29 secure the fork leg tubes 1 on the upper fork tree 27, or the lower fork tree 28. The steering stem bolt 331 can be placed in the upper fork tree 27 or the lower fork tree 28. The upper fork tree 27 is preferable.

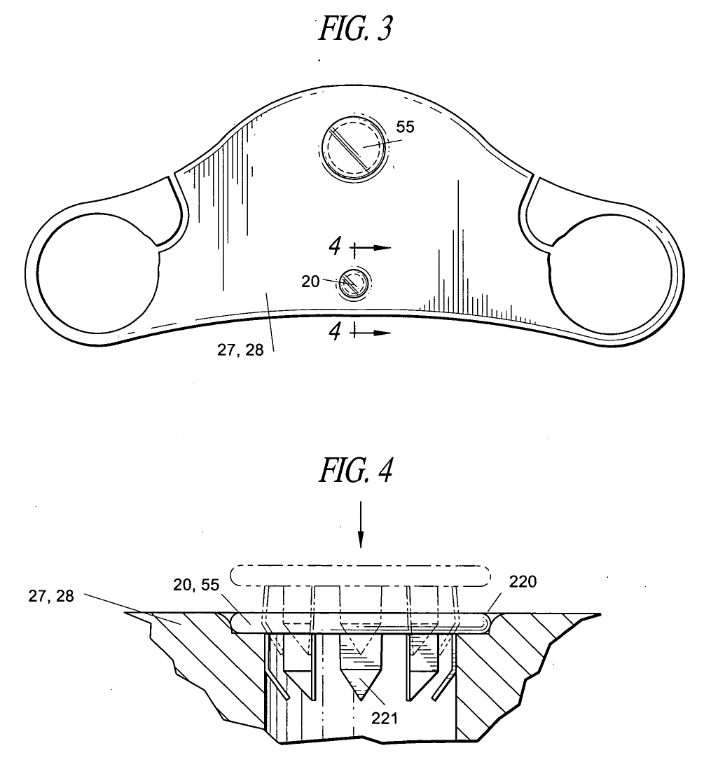

The upper fork tree or lower fork tree 28 as shown in FIG. 3 has a generally flat surface and button 55 and button 20 fit within the apertures. FIG. 3 indicates a smaller button cross section view that is FIG. 4. FIG. 4 shows the headlight button 20 also called the small button 20 that has a configuration similar to the large button 55 configuration.

Both buttons sit on a circumferential shelf 220 and with prongs 221 engaging with the inside surface of the fork tree aperture. The prongs are formed as flat protrusions protruding away from the bottom surface of the button. The protrusions have a perpendicular section terminating in an inward bent tip. The inward bent tip rests approximately forty five degrees from the sidewall of the inside surface of the fork tree aperture. Therefore, the prongs have a pair of sections. Both buttons preferably have inward bent tip prong connectors.

The prongs are arranged in regular intervals as shown in the figures. A total of eight prongs 221 are present as shown in FIG. 4. The surface of the fork tree 27 includes a rounded edge 201 formed about the circumference of the opening for the button. The rounded edge 201 has a radius of curvature approximately equal to the radius of curvature of the button edge. The button 20, 55 inserts manually and when inserted remains flat with the flat surface of the fork tree. The button may have a surface treatment applied that is the same as the fork tree allowing similar surface treatment. For example, if the fork tree is to be chromed, the button may also be chromed. Although a circular button is shown in the figures, other shapes can be provided. A circular button is preferable because it adapts to the circular aperture in the fork tree.

1. A fork assembly comprising:
a. a lower fork tree; a steering stem aperture formed in the lower fork tree; and
b. a steering stem having a lower end that fits within the steering stem aperture;
c. a button fitting within a bottom opening of the lower fork tree covering the lower end of the steering stem within the lower fork tree.

2. The fork assembly of claim 1, wherein the button has prongs formed as flat protrusions engaging with an inside surface of the steering stem aperture, wherein the prongs protrude away from the bottom surface of the button in a first section and terminate in an inward bent tip in a second section.

3. The fork assembly of claim 1, further comprising a circumferential rounded edge having a radius of curvature approximately equal to the radius of curvature of the button edge.

4. The fork assembly of claim 1, further comprising a circumferential shelf formed on the bottom opening of the steering stem aperture, wherein the steering stem aperture has a threaded portion and a shelf portion.

5. The fork assembly of claim 1, further comprising:
a. a headlight aperture formed in the upper fork tree; and
b. a button fitting within the headlight aperture of the upper fork tree.

6. A fork assembly comprising:
a. an upper fork tree; a steering stem aperture formed in the upper fork tree; and
b. a steering stem having an upper end that fits within the steering stem aperture;
c. a button fitting within an upper opening of the upper fork tree covering the upper end of the steering stem within the upper fork tree.

7. The fork assembly of claim 6, wherein the button has prongs formed as flat protrusions engaging with an inside surface of the steering stem aperture, wherein the prongs protrude away from the bottom surface of the button in a first section and terminate in an inward bent tip in a second section.

8. The fork assembly of claim 7, further comprising a circumferential shelf formed on the top opening of the steering stem aperture.

9. The fork assembly of claim 6, further comprising a circumferential rounded edge having a radius of curvature approximately equal to the radius of curvature of the button edge.

10. The fork assembly of claim 6, further comprising a circumferential shelf formed on the top opening of the steering stem aperture, wherein the steering stem aperture has a threaded portion and a shelf portion.

11. The fork assembly of claim 6, wherein the button is flush with an upper surface of an upper fork tree.

12. The fork assembly of claim 6, further comprising:
a. a headlight aperture formed in the upper fork tree; and
b. a headlight button fitting within the headlight aperture of the upper fork tree.

13. The fork assembly of claim 12, wherein the headlight button has prongs formed as flat protrusions engaging with an inside surface of the headlight aperture, wherein the prongs protrude away from the bottom surface of the button in a first section and terminate in an inward bent tip in a second section.

14. A fork assembly comprising:
a. an upper fork tree;
b. a headlight aperture formed in the upper fork tree; and
c. a headlight button fitting within the headlight aperture of the upper fork tree.

15. The fork assembly of claim 14, further comprising a circumferential shelf formed on the top opening of the headlight aperture.

16. The fork assembly of claim 15, wherein the headlight button has prongs formed as flat protrusions engaging with an inside surface of the headlight aperture, wherein the prongs protrude away from the bottom surface of the headlight button in a first section and terminate in an inward bent tip in a second section.

17. The fork assembly of claim 15, further comprising a circumferential rounded edge having a radius of curvature approximately equal to the radius of curvature of the headlight button edge.

18. The fork assembly of claim 14, further comprising:
a. a steering stem aperture formed in the upper fork tree; and
b. a steering stem having an upper end that fits within the steering stem aperture;
c. a steering stem button fitting within a steering stem opening of the upper fork tree covering the upper end of the steering stem within the upper fork tree.

19. The fork assembly of claim 18, wherein the steering stem button has prongs formed as flat protrusions engaging with an inside surface of the headlight aperture, wherein the prongs protrude away from the bottom surface of the button in a first section and terminate in an inward bent tip in a second section.
